(19) United States
(12) Patent Application Publication
(10) Pub. No.: US 2017/0293981 A1
(43) Pub. Date: Oct. 12, 2017

(54) LINKING EXTERNAL PROFESSION DATA TO SOCIAL NETWORK

(71) Applicant: LinkedIn Corporation, Mountain View, CA (US)

(72) Inventors: Krishnaram Kenthapadi, Sunnyvale, CA (US); Stuart MacDonald Ambler, Longmont, CO (US); Ryan Wade Sandler, San Francisco, CA (US)

(21) Appl. No.: 15/092,099

(22) Filed: Apr. 6, 2016

(51) Int. Cl. G06Q 50/00; G06F 17/30

(52) U.S. Cl. CPC G06Q 50/01; G06F 17/30867; G06F 17/30554; G06F 17/30528

(57) ABSTRACT

Generally discussed herein are methods, systems, and apparatuses for harmonizing information from different taxonomies and providing career information based on the harmonized information. A method can include receiving a request for the career information, the request including one or more job titles and one or more job locations associated with the job titles, mapping the one or more job titles to one or more profession titles, mapping the one or more job locations to one or more profession locations, executing a query for statistics associated with the career information, the query including the one or more profession titles and the one or more profession locations to which the one or more job titles and the one or more job locations respectively map, and providing the career information based on the statistics returned from executing the query.

### TECHNICAL FIELD

Examples generally relate to systems, apparatuses, and methods for data analytics. One or more embodiments regard providing a job recommendation based on the data analytics. One or more embodiments regard correlating information from multiple sources that organize information in different manners to provide a more complete data set from which statistics, a job recommendation, or other career information can be provided.

### BACKGROUND

To help provide more complete job information (e.g., a job recommendation, salary data, career planning information, among others, such as on a regional or location-based scale), data can be aggregated. However, data aggregation is fraught with difficulties, thus making the provisioning of more complete job information complicated. Providing a recommendation for a job is also a difficult task. A job can be matched based on desired attributes of an applicant and actual attributes of the applicant. If the attributes sufficiently overlap, the job can be recommended. Some solutions provide a job recommendation based on a distance between a matrix representing the desired attributes and a matrix representing the attributes of the user.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed herein.

FIG. 1 illustrates, by way of example, a block diagram of an embodiment of a system including occupation data stored in accord with multiple, different taxonomies.

FIG. 2 illustrates, by way of example, a block diagram of an embodiment of a system for mapping a job title determined in accord with a job title taxonomy with a profession title determined in accord with a different profession title taxonomy (or vice versa).

FIG. 3 illustrates, by way of example, a block diagram of an embodiment of a system for mapping a job location determined in accord with a job location taxonomy to one or more profession location(s) determined in accord with a profession location taxonomy (or vice versa).

FIG. 4 illustrates, by way of example, a logical block diagram of an embodiment of a system for generating a mapping between pairs of [profession location, profession title] to [job location, job title] (or vice versa).

FIG. 5 illustrates, by way of example, a logical block diagram of an embodiment of a system for generating a job recommendation and/or salary data.

FIG. 6 illustrates, by way of example, a block diagram of an embodiment of a method for providing career information to a user.

FIG. 7 illustrates, by way of example, a block diagram of an embodiment of a computer network environment in which the systems and methods discussed herein can be deployed and/or performed.

FIG. 8 illustrates, by way of example, a block diagram of an embodiment of a system including a software architecture, which may be used in conjunction with various hardware architectures herein described.

FIG. 9 illustrates, by way of example, a block diagram of an embodiment of components of a machine able to read instructions from a machine-readable medium (e.g., a machine-readable storage medium) and perform any one or more of the methodologies or functionality of a module or processor discussed herein.

### DETAILED DESCRIPTION

Discussed generally herein are systems, devices, and methods for career-based data analytics. One or more embodiments regard providing a job recommendation based on the data analytics. One or more embodiments regard correlating information from multiple sources that organize information in different manners to provide a more complete data set from which to base a job recommendation, career statistics, or other career information, such as to help improve a quality of the career information.

Although professional social networks, such as LinkedIn (accessible at www.linkedin.com and managed by LinkedIn Corporation of Mountain View, Calif.), possess unique data about their members, available jobs, companies, professions, regions, among other data. There is tremendous value in augmenting this data with other professional data (e.g., geographically based professional data) from external sources, such as data from the Bureau of Labor Statistics (BLS). For example, consider a technical goal of creating the world's most robust and accurate source of publicly available compensation information. This compensation information (e.g., salary, hourly wage, or other compensation data) can help members better discover and assess career opportunities. A more complete data set can make use of compensation related datasets to help enhance accuracy of statistics or a recommendation provided based on the data. However, the external datasets are likely to follow a different taxonomy of professions and geographic divisions as compared to the data of the professional social network.

A taxonomy is a classification scheme. In the context of job titles, a job title taxonomy is a complete set of possible job titles used by an entity (i.e. the social networking site or an external entity that manages or creates the external database of data). Each job description provided by a user of a social networking site is mapped to a job title in the taxonomy job titles. Similarly, a taxonomy is used for location(s). For example, one entity can have a taxonomy of locations that includes zip codes, while another entity can include a taxonomy of locations that includes states, cities, counties, neighborhoods, or the like. Harmonizing data from disparate taxonomies can be challenging.

Consider a taxonomy that breaks location into zip codes and a taxonomy that breaks location into cities and greater metropolitan areas. If the city or greater metropolitan area spans multiple zip codes or does not span an entire zip code, it is difficult to determine which city/greater metropolitan area a zip code corresponds to or vice versa. The systems, devices, and methods discussed herein can help resolve these types of issues.

Discussed herein is a systematic framework for incorporating the external datasets by generating mappings from the external taxonomy (a taxonomy of the external data) to internal taxonomies (a taxonomy of the social network data). The underlying mappings can be based on population and/or member demographic information for mapping regions and titles. As a result, we can provide a priori compensation insights based on the external sources, thereby expanding the quality of the recommendation or statistics. This information can be used to increase accuracy of requested statistics and/or a job recommendation provided based on the information.

Discussed herein, among other things, are the following topics: (1) mapping internal job title(s) taxonomy to profession title(s) in an external dataset; (2) mapping internal region(s) to external region(s); (3) mapping internal region(s) to external region(s) based on job title; (4) mapping internal (job title, region) to external (profession title, region); (5) generating statistics for internal (job title, region) pairs by aggregating over mapped external (profession title, region) pairs; and (6) providing a job recommendation based on one or more of (1)-(5).

Reference will now be made to the figures to describe details of one or more embodiments. Generally, an embodiment is discussed with reference to a social network system that can include member profile information gathered from its individual members, however, the system is not limited to this context. The system(s), apparatus(es), and method(s) can be implemented using processing circuitry (e.g., one or more hardware processors or other processing circuitry, such as electric or electronic components that can include one or more resistors, transistors, capacitors, inductors, logic gates (e.g., AND, OR, NOT, EXOR, or the like), oscillators, multiplexers, or the like) and/or one or more modules. The modules o processors can be implemented on a computing device as a standalone, add-on, or plug-in for another application, among other implementations.

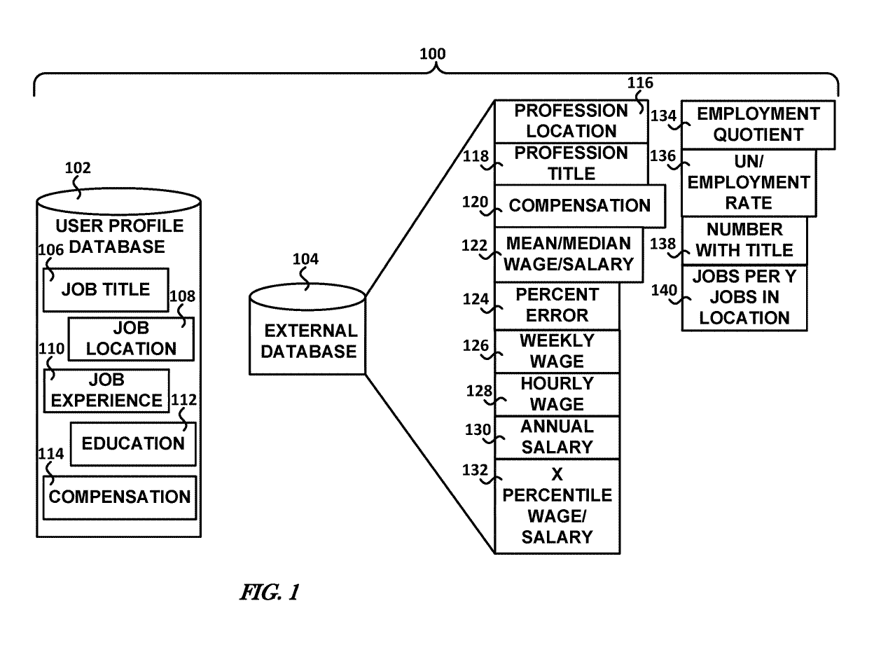

FIG. 1 illustrates, by way of example, a block diagram of an embodiment of a system 100 including occupation data stored in accord with multiple, different taxonomies. The system 100 includes a database 102 with data stored thereon in accord with an internal taxonomy and a database 104 with data stored thereon in accord with another taxonomy. While the FIGS. illustrate the concepts of harmonizing data from different taxonomies with regard to jobs, the concepts of harmonizing data can be applied to a variety of data stored in databases in accord with different taxonomies.

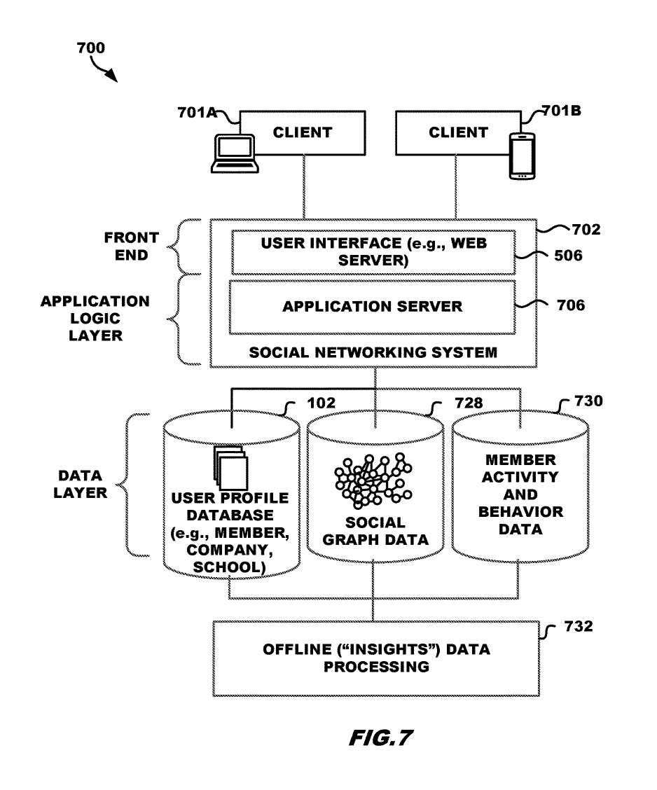

The database 102 includes information received from or inferred about users of a social networking site. The data can be stored in any general format, such as JSON, XML, HTML, XLS, or the like. The data as illustrated includes job title 106, job location 108, job experience 110, education 112, and compensation 114. This data is merely an example and it will be understood that other member data can be stored in the database 102 and used in the context of this disclosure, such as data discussed with regard to FIG. 7.

The job title 106 for each user includes one or more titles of a taxonomy of titles used by the social networking site. For example, LinkedIn uses over twenty thousand (20,000) titles in their job title taxonomy. The job location 108 for each user is one location of a taxonomy of locations used by the social networking site. For example, LinkedIn uses over two hundred fifty (250) locations in their location taxonomy.

The job experience 110 can include a number of years in a field related to the job title 106. For example, if a user has worked as an engineer for six years, the job experience can include the six years, each of the job titles in that six years, and/or a time duration at each of the job titles in that six years, or the like. The education 112 can include a title of degree(s) attained, institution(s) which issued the degree(s), date(s) in which the user attended the institution(s), date(s) spent at an institution in which a degree was not attained, honors, awards or publications attained while attending the institution(s), or other education related information. The compensation 114 can include a salary or wage for a specific amount of time worked (e.g., an hour, week, month, quarter, year, or the like).

The database 104 includes information from an external entity (external to the social networking site). The data can be stored in any general format, such as Java Script Object Notation (JSON), Extensible Markup Language (XML), HyperText Markup Language (HTML), Excel Spreadsheet (XLS), or the like. The data as illustrated includes profession location 116, profession title 118, data under a compensation category 120, such as mean/median wage salary 122, percent error 124, weekly wage 126, hourly wage 128, annual salary 130, and X percentile wage/salary 132, employment quotient 134, un/employment rate 136, number with title 138, and jobs per Y jobs in location 140. This data is merely an example and it will be understood that other data can be stored in the database 104 and used in the context of this disclosure.

The profession title 118 for each user is one title of a taxonomy of profession titles used by the external entity. For example, BLS uses over eight hundred (800) titles in their profession title taxonomy. The profession location 108 for each user is one location of a taxonomy of locations used by the external entity. For example, BLS uses about five hundred (500) locations in their location taxonomy.

The compensation information under the compensation category 120 are merely examples of data provided by the BLS. Different data can be provided or obtained by other entities without departing from the scope of this disclosure. The mean/median wage/salary 122 is a measure of a central salary/wage value of others with the same profession title 118 in the same profession location 116. A mean is a sum over all values in the category divided by the number of values in the category. The median is the middle wage/salary in an ordered list of the wages/salaries (e.g., ordered from smallest to greatest wage/salary or vice versa). The percent error 124 is a measure of confidence in the data to which the percent error 124 is related. The lower the percent error, the more confidence there is that the data to which the percent error 124 is related is true. The weekly wage 126, hourly wage 128, and annual salary 130 are specific examples of monetary compensation. These can be individual entries or averages over entries. The X percentile wage/salary 132 details what wage/salary is at the Xth percentile of person(s) with the profession title 118 in the profession location 116. X can be any value between and including zero (0) and one hundred (100). For example, if X is seventy-five (75), the data in the X percentile wage/salary 132 indicates that only twenty-five (25) percent of all people in the profession location 116 with the profession title 118 reported having a greater income in the relevant time frame.

The employment quotient 134 represents the ratio of a profession's share of employment in a given area to that profession's share of employment in the U.S. as a whole. For example, an occupation that makes up ten (10) percent of employment in a specific location compared with two (2) percent of U.S. employment would have an employment quotient of 5 for that location. Note that employment quotient 134, instead of being determined on a national level (e.g., the U.S.) can be determined on a state, county, city, zip code, or other level that includes multiple sub-regions. The un/employment rate 136 indicates how many people were unemployed/employed in the profession location 116 for the relevant time. The number with title 138 indicates how many people in the profession location 116 have the profession title 118. The jobs per Y jobs in location 140 indicates how many jobs with the profession title 118 there are relative to Y jobs in the profession location 116. For example, consider that there are three hundred (300) garbage collector jobs in Bismarck, N. Dak. and there are sixty-six thousand (66,000) total jobs in Bismarck. The jobs per Y jobs in location 140, when Y is one thousand (1000) in this example is about four and a half (4.5).

Consider trying to harmonize the data in the databases 102 and 104, such as by responding to a request based on data from both databases 102 and 104, or providing a recommendation based on data from both databases 102 and 104. The data includes two different taxonomies for occupation title (job title in database 102 and profession title in database 104) and data includes two different taxonomies for job location (job location in the database 102 and profession location in the database 104). Now consider answering a question “how much does a registered nurse, on a yearly average, make in the New York, N.Y. area?” based on a combination of both sets of data. “Registered nurse” may be lumped in with other nurses in one profession title taxonomy, may be split into multiple categories in a job title taxonomy, or may be a single category in another taxonomy. Further, the “New York, New York” region may be different in both the databases 102 and 104. The respective regions may overlap, but one location taxonomy may consider northern New Jersey part of the New York, N.Y. area, while the other taxonomy does not, and another location taxonomy may consider upstate New York to New Paltz part of the New York, N.Y. area, while the other location taxonomy does not. The subject matter discussed herein can help in answering this, and other requests, based on information from both the databases 102 and 104.

Consider another example of providing a job recommendation to a user based on data in both databases, such as to give a recommendation based on a more complete view of the job landscape. The same issues as discussed with answering the previous discussion may be encountered. Consider a specific example in which a user with ten (10) years of experience in database design and management is looking for a job in the San Francisco Bay area. The profession taxonomy may not include a specific title for a database design or database management job, but may include one or more profession titles that can include titles that perform operations related to database design or database management. Also, the location taxonomy for “San Francisco Bay area” can include differing regions in accord with respective location taxonomies. The subject matter discussed herein can help in providing a job recommendation, such as by harmonizing the information from the databases 102 and 104.

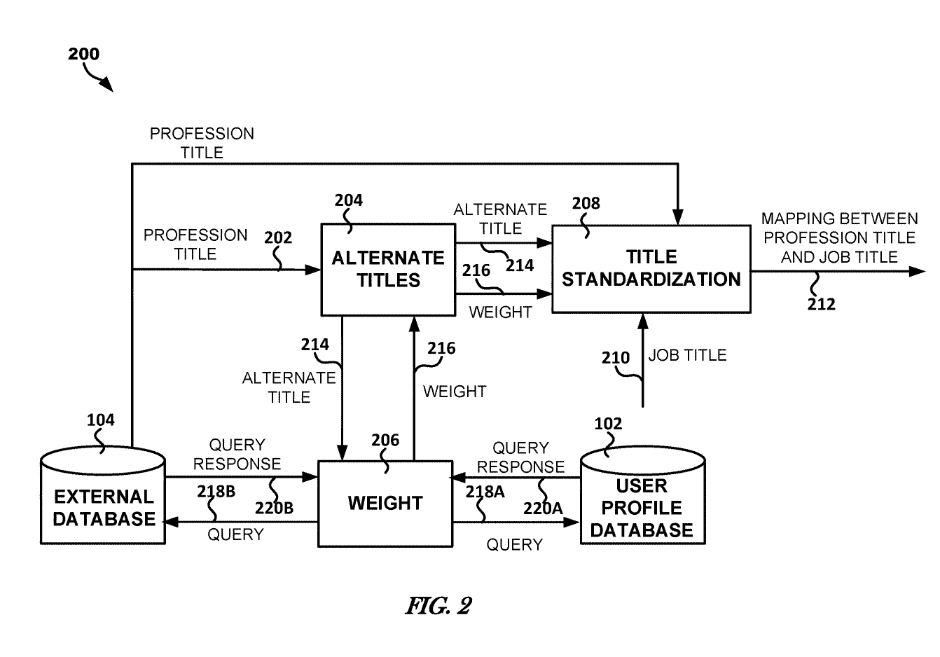

FIG. 2 illustrates, by way of example, a block diagram of an embodiment of a system 200 for mapping a job title determined in accord with a job title taxonomy with a profession title determined in accord with a different profession title taxonomy (or vice versa). The system 200 as illustrated includes profession titles 202 from the profession taxonomy used in the database 104, an alternate titles processor 204, a weight processor 206, a title standardization processor 208, job titles 210 from the internal taxonomy used in the database 102, and a mapping 212 as an output. While the system 200 shows the profession titles 202 being mapped to job titles 210, the two taxonomies of occupation titles can be exchanged for one another. For example, if the profession titles 202 includes more occupation titles than the job titles 208, the job titles 208 can be mapped to the profession titles 202.

The profession titles 202 are occupation titles determined in accord with an external occupation title taxonomy as used for data stored in the database 104. In the example being described in FIG. 2 it is assumed that there are fewer occupation titles in the taxonomy corresponding to the profession titles 202 than there are in the taxonomy corresponding to the job titles 208.

The alternate title processor 204 takes a title as an input and produces one or more other occupation titles as an output. The produced occupation title(s) are other titles used for the title that was input. For example, if “software developer” is an input, than the output can include “software engineer”, “computer programmer”, “software design”, “application developer”, “developer”, “senior software engineer”, “coder”, “architect”, “software architect”, “software analyst”, and/or “software researcher”. These alternate titles can be determined using a thesaurus to find one or more synonym(s) for words in the profession title, a pre-defined list of alternate titles, or using an off the shelf program, such as “Alternate Titles” from The Occupational Information Network (O*NET). O*NET is a free online database that includes, for each occupation the skills and knowledge required to perform the work of the occupation; the abilities, interests and values needed to perform the work of the occupation; the training and level of licensing and experience needed for the work of the occupation; the work activities and context, including the physical, social, and organizational factors involved in the work of the occupation; and the occupational outlook and the pay scale for the work. Alternate Titles is available at https://www.onetcenter.org/dictionary/20.1/excel/alternate_titles.html (last accessed Mar. 14, 2016). The thesaurus, off-the shelf program, or other alternate titles determination mechanism, can be accessed via a server, application programming interface (API), or by making a call to a function that performs the alternate title determination, for example, among other possible configurations.

The optional weight processor 206 takes one or more alternate titles 214 as input and produces a weight 216 for each of the one or more alternate titles 214 as output. The weight 216 can be determined using a variety of heuristics. Some example heuristics include weighting a title according to a fraction of employees in the occupation that have the alternate title, proportion of people in a defined region that have the alternate title, an economic indicator, such as gross domestic product (GDP) of the region, median home price of the region, cost of living in the region, among others. Note that some of the heuristics make sense in some circumstances and may not make sense in other circumstances. For example, giving a weighting factor based on GDP of zip code when answering a question about mean salary in a given region may not make as much sense as giving a weighting factor based on GDP of a region in the context of providing a job recommendation.

To determine the weight 216, the weight processor 206 can issue a query 218A and/or 218B to one or more relevant database(s) (e.g., the external database 104 and/or the user profile database 102). The query 218A-B can be for data needed to determine the weight 216. For example, if the heuristic indicates that the weight 216 is to be the fraction of employees in the occupation that have the alternate title the query 218A-B is configured to determine the number of employees in the occupation and the number of employees with the title. Using this information, the weight processor 206 can then determine the weight 216.

The title standardization processor (TSP) 208 takes the profession title 202, job titles 208, alternate title(s) 214, and optional weight(s) 216 as input and produces the mapping 212 as an output. The TSP 208 determines which titles of the set of [profession title, alternate titles] are present in the set of [job titles]. This can be done by performing an intersect operation between the sets [profession title, alternate titles] and [job titles] (i.e. possible titles=[profession title, alternate titles] CI [job titles]). The mapping 212 can include the profession title, one or more possible title(s) from the job title taxonomy that are associated with the profession title, and/or a weight associated with each of the possible title(s) (e.g., [profession title, alternate title₁, weight₁, alternate title₂, weight₂, . . . alternate titleⱼ, weightⱼ]). The weight in this context can be an aggregate of alternate titles 214 that link the profession title 202 to the job title 210.

Consider an example in which the profession title is “software developer” as previously discussed. Consider that in this example the alternate titles processor 204 and weight processor 206 produce alternate titles 214 and corresponding weights 216 as {[“software engineer”, 0.1]; [“computer programmer”, 0.2]; [“software design”, 0.05]; [“application developer”, 0.05]; [“developer”, 0.3]; [“senior software engineer”, 0.05]; [“coder”, 0.005]; [“architect”, 0.005]; [“software architect”, 0.005]; [“software analyst”, 0.2]; [“software researcher”; 0.005]}. Consider further that the job title taxonomy in the database 102 includes “software engineer”, “computer programmer”, “software design”, “senior software engineer”, “software analyst”, and “software researcher”. The mapping 212 can include {[“software engineer”, 0.1]; [“computer programmer”, 0.2]; [“software design”, 0.05]; [“senior software engineer”, 0.05]; [“software analyst”, 0.2]; [“software researcher”; 0.005]}.

In one or more embodiments, the TSP 208 can normalize the weights associated with a given profession title or job title, such as to make the weights sum to one. To do this, each weight can be transformed in accord with normalized_weight=weight/sum(weights).

In embodiments that do not include the weight processor 206, all occupation titles in the set [alternate titles, profession title] that exist in the job title taxonomy can be returned in the mapping 212. In one or more embodiments, the title standardization processor 208 can combine a confidence score with the weight 216. The confidence score can be determined based on information in one database when the weight is determined based on information in the other database. The confidence score can be combined with the weight, such as by multiplying the two numbers, and the resultant combined score can be provided in the mapping 212. The confidence score can be an indication of how likely it is that the given title from the set [profession title, alternate titles] is the actual title. The confidence score can be determined based on the number of people in the occupation with the title relative to other titles in the set. The confidence score and weight combination can be normalized in a manner similar to normalizing the weight previously discussed.

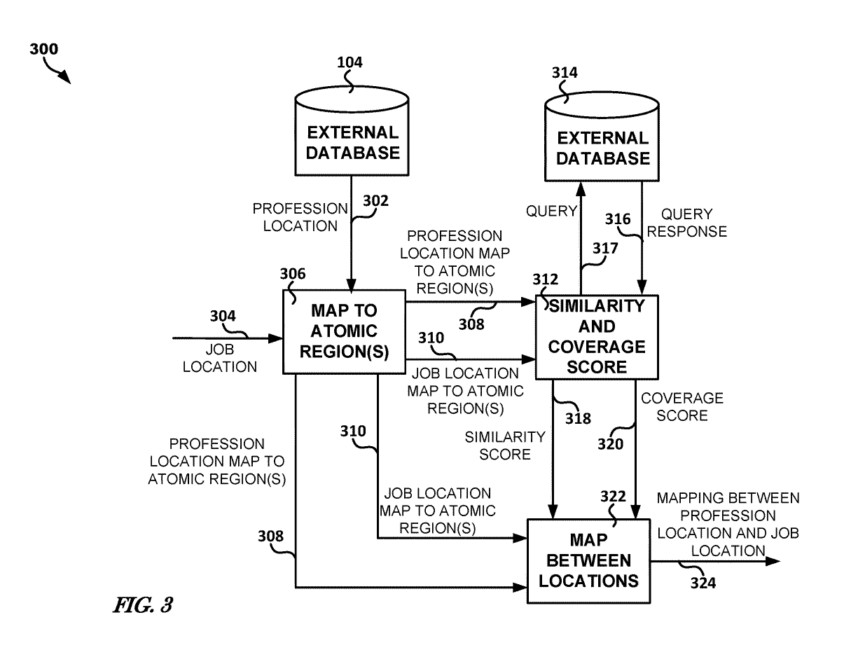

FIG. 3 illustrates, by way of example, a block diagram of an embodiment of a system 300 for mapping a job location determined in accord with a job location taxonomy to one or more profession location(s) determined in accord with a profession location taxonomy (or vice versa). The system 300 as illustrated includes a job location 304 from the user profile database 102, a profession location 302 from the external database 104, a map to atomic region(s) processor 306, a similarity and coverage score processor 312, a map between locations processor 322, and a mapping between profession location and job location 324 as an output.

The job location 304 generally identifies a geographic region in which the job is performed. The geographic region for the job location 304 is a geographical region from a location taxonomy used by the social networking site. The geographic region can be specified in a number of ways, such as by city, neighborhood, zip code, state, multiple states that make up a region (e.g., west coast, east coast, north, south, southwest, midwest, or the like), county, or the like. Similarly, the profession location 302 identifies a geographic region, but identifies the geographic region in accord with a different taxonomy for defining the geographic region. The profession location 302 and the job location 304 may be defined in accord with two different taxonomies (i.e. each taxonomy splits geographical regions into units that are different). For example, one taxonomy could split the geographical region by zip code, while the other taxonomy splits the geographical region by city boundaries.

The map to atomic region(s) processor 306 takes the profession location 302 and the job location 302 as input and produces an output that includes the profession location mapping to atomic regions(s) 308 and the job location mapping to atomic region(s) 310. An atomic region is a geographical region, such as a city, neighborhood, zip code, state, multiple states that make up a region (e.g., west coast, east coast, north, south, southwest, midwest, or the like), county, or the like. Consider an embodiment in which the profession location or the job location is specified in terms of metropolitan areas and the atomic region is zip codes. The Minneapolis/St. Paul, Minn. metro area maps to over one hundred (100) zip codes. The map to atomic region(s) 306 takes the job location 304 and profession location 302 and maps each them to such atomic region(s). This mapping can be accomplished based on longitude and latitude coordinates, GPS coordinates that define boundaries of the region, or other geographical mapping coordinate system. The coordinates can be compared to determine if the region(s) overlap and/or a degree to which they overlap. In the example discussed, assuming the profession location 302 is Minneapolis/St. Paul and the atomic region(s) are zip code(s), the map to atomic region(s) processor 306 can produce an array of zip codes corresponding to the Minneapolis/St. Paul area. Adding to this example, consider that the job location 304 is just St. Paul, the map to atomic region(s) processor 306 can produce an array of zip codes corresponding to just St. Paul (a subset of the Minneapolis/St. Paul metro area zip codes).

The similarity and coverage score processor 312 receives the profession location map to atomic region(s) (PLMAR) 308 and the job location map to atomic region(s) (JLMAR) 310 and produces a similarity score 318 between the two sets of atomic region(s) 308 and 310. The similarity score can be based on atomic region population data 316, in one or more embodiments. The atomic region population data 316 can be from another database 314, such as from the United Sates Census Bureau.

The similarity score 318 is a measure of how much the PLMAR 308 and the JLMAR 310 are alike. The similarity score 318, in one or more embodiments, can be a Jaccard coefficient of the atomic regions mapped to the job location and the atomic regions mapped to the profession location (i.e. Jaccard (atomic regions_{job}_{_}_{location}, atomic regions_{profession}_{_}_{location})=(atomic regions_{job} _{_}_{location}∩atomic regions_{profession}_{_}_{location})/(atomic regions_{job}_{_}_{location})/(regions_{profession}_{_}_{location}), where atomic regions_{job}_{_}_{location} is the atomic regions in the PLMAR 308 and atomic regions_{profession}_{_}_{location} is the atomic regions in the JLMAR 310. The Jaccard coefficient can be weighted, such as by multiplying the entries in the PLMAR 308 and the JLMAR 310 by respective weights prior to computing the Jaccard coefficient. The weights can be based on a proportion of the population in the given atomic region as defined in the atomic region population data 316. If the population is relatively higher in a given atomic region the weight can be higher. In or more other embodiments, the weights can be based on a proportion of land area occupied by the given atomic region as defined in data in the external database 314. Such land area data is available from ProximityOne of Independence, Mo., United States, and available on their website at http://proximityone.com/cen2010_zcta_dp.htm. In one or more other embodiments, the similarity score 318 can include a total population in an intersection of the PLMAR 308 and the JLMAR 310 and dividing by a population in the union of the PLMAR 308 and the JLMAR 310.

In one or more embodiments, the weights given to respective atomic regions are based on a number of people with one or more given occupation title(s) (e.g., the job title 204, the profession title 202, and/or the alternate title(s) 214). This data can be gathered (e.g., inferred) from issuing a query to the user profile database 102, the external database 104, and/or the external database 314. The connections between the similarity and coverage score processor 312 and the databases 102 and 104 that would be used in such embodiments are not shown so as to not obscure the view of FIG. 2.

The coverage score 320 is a measure of geographic overlap between the PLMAR 308 and the JLMAR 310. The coverage score 320 can include a total land area in an intersection of the PLMAR 308 and the JLMAR 310 divided by a total land area in the union of the PLMAR 308 and the JLMAR 310. The coverage score 320 can be determined based on an amount of overlap between regions defined by coordinates (e.g., latitude and longitude, GPS, or other geographical coordinate system).

The map between locations processor 322 receives the PLMAR 308, JLMAR 310, similarity score 318, and coverage score 320 as inputs and generates the mapping between profession location and lob location (MBPLJL) 324 as output. The map between locations processor 322, in one or more embodiments, uses a multivariable, monotonically increasing function in two or more variables (e.g., where the two or more variables in include the similarity score 318 and the coverage score 320) to determine the MBPLJL 324. In one or more embodiments, the function is f(x,y)=x#y, where # is an operation, such as multiplication, division, addition, subtraction, a power, a root, or a combination thereof. Consider an example in which the job location 304 is Minneapolis/St. Paul area and the corresponding region in the taxonomy used by the profession location 302 is by municipality so there are two hundred-eighteen (218) regions. The MBPLJL 324 can include a listing of all 218 municipalities for a mapping of the job location 304 to the profession location 302. Each of the municipalities in the list can include a corresponding weight, such as can be some combination of the coverage score 320 and/or the similarity score 318, in one or more embodiments. A mapping from St. Paul from the profession location 302 to the job location 304 can be of the form [Minneapolis/St. Paul metro, weight] where weight is some measure of the proportion of the population (e.g., the similarity score 318) and/or land area (e.g., the coverage score 320) of the Minneapolis/St. Paul metro that is consumed by St. Paul.

In one or more embodiments, the land area or atomic region population data 316 may not be available or may not be used. In such embodiments, all regions that overlap (even partially) may be returned and may be unweighted.

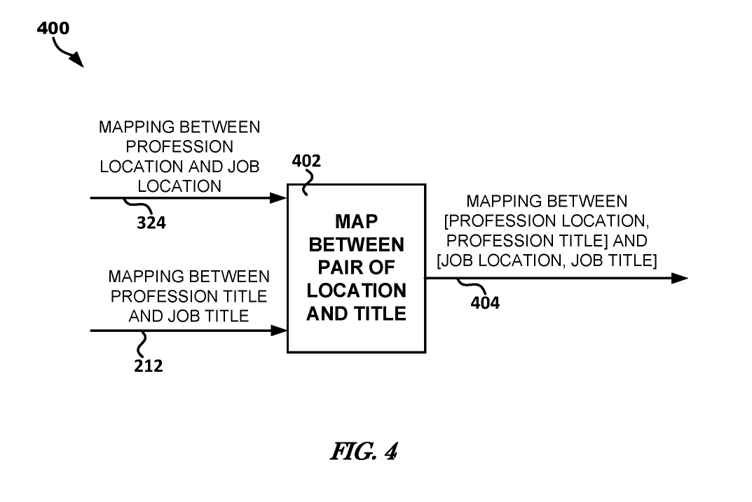

FIG. 4 illustrates, by way of example, a logical block diagram of an embodiment of a system 400 for generating a mapping between pairs of [profession location, profession title] and [job location, job title] (or vice versa). The system 400 as illustrated includes the output from the system 200, the mapping between profession title and job title 212, and the output from the system 300, the mapping between profession location and job location 324, as inputs to a map between pair of location and title (MBLT) processor 402. The MBLT processor 402 generates a mapping between [profession location, profession title] and [job location, job title] an output 404.

In one or more embodiments, the MBLT processor 402 is optional and not needed. Such embodiments can include embodiments in which the atomic region is considered by the system 200 or the title is considered by the system 300. In such embodiments, the title and location mapping is provided by the title or location mapping with a combination of an associated weight.

In one or more other embodiments, such as those that do or do not include weights from the system 200 or the system 300, the mapping between [profession location, location] to [job title, job location] can be a combination of the mapping between profession title and job title 212 and mapping between profession location and job location 324 without any additional processing.

In one or more embodiments that include weights associated with the mapping between profession title and job title 212 and mapping between profession location and job location 324, the MBLT processor 402 can transform the two mappings to a mapping that combines corresponding weights. In one or more embodiments, the transformation performed by the MBLT processor 402 includes a multiplication of the two weights, a weighted multiplication of the two weights, such as to prioritize one of the weights over the other weight, an addition of the two weights, a power (e.g., square root, cubed root, square, cube, or the like) of one or more of the weights along with another operation between the two weights, an average of the two weights, choosing the larger weight as the combined weight, choosing the smaller weight as the combined weight, or the like. The combination of weights, in one or more embodiments, can include using the weights as inputs to a monotonically increasing function (e.g., x*y, x+y, x²*y, etc., where x and y are the weights associated with a professional title to job title mapping and a professional location to job location mapping, respectively). In one or more embodiments, the MBLT processor 402 can normalize the combined weights, such that weights add to one, such as is previously discussed.

Mapping operations can include, for example, performing a join operation between data to be associated or setting a character string equal to the union of the data to be associated. Other functions can be used to map data.

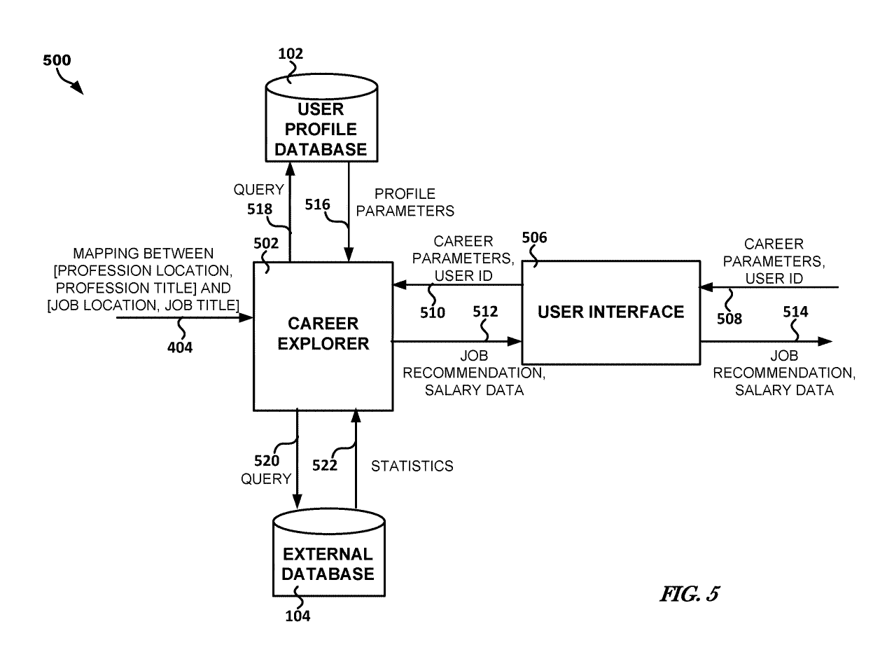

FIG. 5 illustrates, by way of example, a logical block diagram of an embodiment of a system 500 for generating a job recommendation and/or salary data 514. The system 500 as illustrated includes a career explorer processor 502 and a user interface 506. The user interface 506 is the area through which a user interacts with the system 500. The user interface 506 is typically presented to a user in the form of graphics on a display. The user can interact with objects on the display by providing some form of input (e.g., keyboard, mouse, voice, touchscreen, or the like) to the user interface 506. The user interface 506 formats the input to be consistent with a format required by the career explorer processor 502. In the example of FIG. 5, the user provides career parameters and/or user identification (user ID) 508 as input 508. The user interface 506 formats the career parameters and/or user ID 508 in a format compatible with the career explorer processor 502 and forwards properly formatted career parameters and/or user ID 510 to the career explorer processor 502.

The career explorer processor 502 receives the career parameters and/or user ID 510, mapping between [profession location, profession title] and [job location, job title] 404, and/or user profile parameters 516 as input. The career explorer processor 502 transforms the input into a job recommendation and/or salary data 512, among other career data. The career explorer processor 502 interprets the career parameters and/or user ID to determine what information is desired. For example, if the career parameters 510 include no user ID, the career explorer processor 502 can understand that salary data (or other job related data) is being requested. In another example, if the career parameters 510 include a user ID, the career explorer processor 502 can understand that a job recommendation is being requested.

The career explorer processor 502 takes the career parameters 510 and determines one or more job titles and/or one or more job locations associated with the career parameters 510. For example, the career parameters 510 can include <job title, job location, statistic>. The career explorer processor 502 can then initiate mapping between the job title and profession title, such as by providing the system 200 with the job title 210, or by looking up the mapping between profession title and job title 212, such as can be stored in a memory and indexed by job title, in one or more embodiments. The career explorer processor 502 can initiate a mapping between the job location and profession location, such as by providing the system 300 with the job location, or by looking up the mapping between profession location and job location 324, such as can be stored in a memory and indexed by job location. The MBPLJL 324 and the MBPTJT 212 can be provided (e.g., automatically, such as by the career explorer processor 502 or by virtue of the communicative coupling between the systems 200, 300, and 400). The mapping between [profession location, profession title] and [job location, job title] 404 is either looked up by the career explorer processor 502 in instances in which the mapping between [profession location, profession title] and [job location, job title] 404 is pre-computed and stored in a memory, such as can be indexed by job location and/or job title, or is provided to the career explorer processor 502 by the system 400 in instances in which the system 400 computes the mapping between [profession location, profession title] and [job location, job title] 404.

The career explorer processor 502 can generate a query 520 based on the mapping between [profession location, profession title] and [job location, job title] 404. For example, if the mapping between [profession location, profession title] and [job location, job title] 404 indicates that the [job location, job title] maps to four different profession titles with corresponding weights, and the job location maps to four different profession locations with corresponding weights the career explorer can query the database 104 for salary or other career data for each of the four careers in each of the four profession locations. The career explorer processor 502 can then combine returned statistics 522 (in this example up to sixteen different numbers (four profession titles at each of four profession locations) in accord with the corresponding weights and provide the combined statistics as the output 512 to the user interface 506.

The query 520, in one or more embodiments, can be of the general form <“Title”=“Profession Title 1” OR “Profession Title 2” OR “Profession Title 3” OR . . . “Profession Title N” & “Profession Location”=“Profession Location 1” OR “Profession Location 2” OR “Profession Location 3” OR . . . “Profession Location N”, “requested career data”>. Such a query can return Each combination of the Professional Title and Profession Location in the query and the associated requested career data if any is available. An example of a data format from the BLS data (data in the database 104) is <profession location, profession title, career data>.

Consider an example in which a user requests mean salary data for software developers in the Silicon Valley area. The systems 200, 300, and 400 can map [Silicon Valley, Software Developer] to the following combinations of <Profession Location, Profession Title, weight>: <San Francisco-Oakland-Fremont, Calif. Software Engineer, Applications, 0.25> <San Jose-Sunnyvale-Santa Clara, Calif. Backend Software Developer, Applications, 0.25> <San Francisco-Oakland-Fremont, Calif. Software Engineer, Systems Software, 0.25> <San Jose-Sunnyvale-Santa Clara, Calif. Backend Software Developer, Systems Software, 0.25>

Consider that the salaries for each of the respective <Profession Location, Profession Title, weight> combinations is 100000, 130000, 110000, and 140000. The career explorer 502 can produce the salary as $120,000, for example (i.e. (100000*0.25+110000*0.25+130000*0.25+140000*0.25)).

Consider an example in which a job recommendation is to be provided to the user interface using the output 512. The career explorer processor 502 can receive a user ID 510 and/or career parameters. The career explorer processor 502 can lookup details of the user's profile by generating a query 518 based on the user ID 510. Profile parameters 516 can be returned to the career explorer based on the user ID 510. The career explorer processor 502 can use one or more job titles from the profile parameters 516 and/or one or more of the job locations from the profile parameters 516 as a starting point for providing the job recommendation. The career explorer processor 502, as previously discussed, can either initiate a mapping from the job title(s) and/or job location(s) to respective profession title(s) and/or profession location(s), respectively, such as by using one or more of the systems 200, 300, and/or 400. Alternatively, the career explorer processor 502, as previously discussed can look up a mapping that has been pre-computed, such as by the system 200, 300, and/or 400. Using the mapping, the career explorer processor 502 can generate a query 520 for statistics 522 regarding one or more of the profession titles and/or profession locations in the mapping. The statistics 522 can include any of the data from the database 104 (see FIG. 1, for example). In one or more embodiments, the career explorer 502 can then, based on the statistics 522, determine if there are any available jobs with a job title or job location associated with the best of the statistics (as determined by some heuristic) and can return one or more available jobs that match the job location and job title criteria. Alternatively, the career explorer processor 502 can provide a ranked list of one or more job titles and/or one or more job locations along with the returned statistics to the user interface 506, such as through the output 512. In such embodiments, a user gets a better view of the overall job landscape. A user can use this information to help inform them where to look for a job.

In ranking the job title and/or job location, the career explorer processor 502 can factor in relative values of the statistics 522 and provide the job title and/or job location that scores highest according to some heuristic. For example, the career explorer processor 502 can rank based on one or more career statistics including mean/median wage salary 122, weekly wage 126, hourly wage 128, annual salary 130, X percentile wage/salary 132, employment quotient 134, un/employment rate 136, number with title 138, and/or jobs per Y jobs in location 140, among other career or economic indicators. The heuristic can be defined as some weighted combination of one or more of the career statistics or economic indicators of the profession or location. The weight for the career statistics can be based on one or more of the other career statistics (e.g., a weight can include 1/unemployment rate (where the unemployment rate is expressed as a number less than one), jobs per Y jobs in location 140, number with title/population of atomic region, or some combination thereof) or economic factors (e.g., GDP of the profession location (higher the GDP the higher the associated weight), cost of living of the profession location (lower the cost of living, higher the associated weight), median house price of the profession location (lower the median house price, higher the associated weight, or the like)). The job title and/or job location with the highest associated score is then provided as the top choice. In one or more embodiments, the job title and/or job location with the highest score provides the basis for searching for an actual job that the user might be interested in.

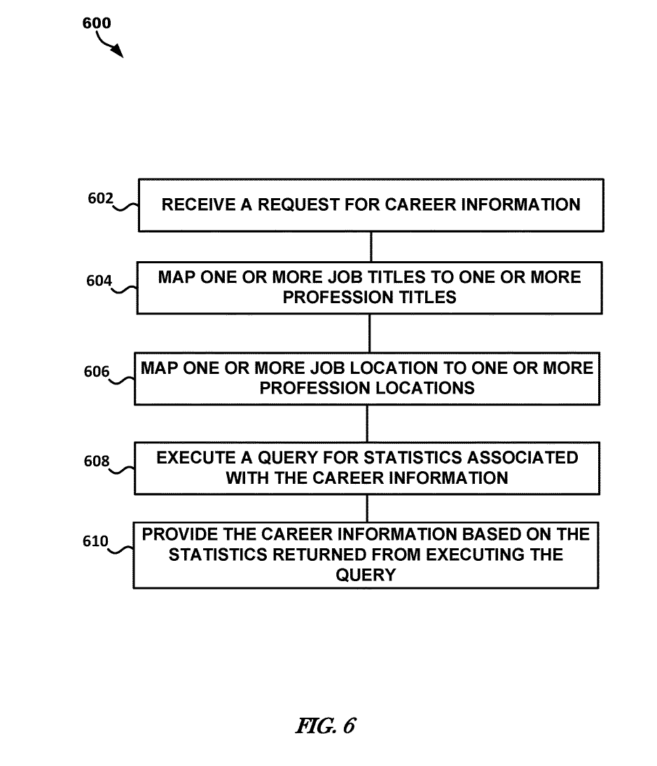

FIG. 6 illustrates, by way of example, a logical diagram of an embodiment of a method 600 for providing a statistic or job recommendation to a user. The method 600 as illustrated includes: receiving a request for career information, at operation 602; mapping one or more job titles to one or more profession titles, at operation 604; mapping one or more job location to one or more profession locations, at operation 606; executing a query for statistics associated with the career information, at operation 608; and providing the career information based on the statistics returned from executing the query, at operation 610. The operation 602 can be performed by the career explorer processor. In one or more embodiments, the request for career information can include one or more job titles and one or more job locations associated with the job titles, the one or more job titles determined in accord with a first title taxonomy used by entries in a first database and the one or more job locations determined in accord with a first location taxonomy used by entries in the first database.

The operation 604 can be performed by a title mapping system communicatively coupled to the career explorer processor. The one or more profession titles can be determined in accord with a second, different title taxonomy used by entries in a second database. The operation 606 can be performed by a location mapping system communicatively coupled to the career explorer processor. The one or more profession locations can be determined in accord with a second, different location taxonomy used by entries in the second database.

The operation 608 can be performed using the career explorer processor. The query can include the one or more profession titles and the one or more profession locations to which the one or more job titles and the one or more job locations respectively map. The operation 610 can be performed using a user interface communicatively coupled to the career explorer processor.

The operation 604 can further include determining alternate titles for each of the one or more profession titles. The operation 604 can further include identifying which of the determined alternate titles and one or more profession titles have an equal job title in the first title taxonomy. The operation 604 can further include associating each of the one or more profession titles that has an associated alternates title or profession title identified to include the equal job title in the first title taxonomy.

The operation 604 can further include determining a weight for each of the alternates titles and profession title identified to include an equal job title in the first title taxonomy, the weight indicating a confidence that the alternate titles or profession title is supposed to map to the equal job title, wherein a sum of all alternate titles and profession titles mapped to a job title in the first title taxonomy is about one. Determining the weight for each of the alternate titles and profession titles identified to include an equal job title in the first title taxonomy can include estimating a proportion of the population of the one or more profession locations or one or more job locations that includes the alternate titles or profession titles, normalizing the estimated proportion such that the summed estimated proportions for a respective job title of the one or more job titles equals about one, and using the normalized estimated proportion as the weight.

The operation 606 can further include mapping each job location of the one or more job locations to one or more atomic regions, the one or more atomic regions determined in accord with the third, different location taxonomy. The operation 606 can further include mapping each profession location of the one or more profession locations to the one or more atomic regions. The operation 606 can further include identifying overlap between atomic regions to which a respective job location is mapped and atomic regions to which a respective profession location is mapped. The operation 606 can further include associating the respective job location with the respective profession location if the identified overlap is not a null set.

The operation 606 can further include determining a coverage score for the associated respective job location and respective profession location, the coverage score indicating an amount of geographic overlap between the respective job location and the respective profession location. The operation 606 can further include associating the coverage score with the associated respective job location and respective profession location. The operation 606 can further include determining a similarity score for the associated respective job location and respective profession location, the similarity score indicating an amount of demographic overlap between the respective job location and the respective profession location, and associating the similarity score with the associated respective job location and respective profession location.

Determining the similarity score can include (1) determining a Jaccard coefficient between the mapped job locations and profession locations; or (2) determining a first population of a first region defined by an intersection between the mapped job location and profession location, determining a second population of a second region defined by a union between the mapped job location and profession location, and dividing the determined first population by the determined second population to produce the similarity score.

FIG. 7 illustrates, by way of example, a block diagram of an embodiment of a computer network environment 700 in which the systems and methods discussed herein can be deployed and/or performed. The system 200, 300, 400, and/or 500 can be deployed or the process 600 can be implemented using the environment 700. In one or more embodiments, the user clients 701A and 701B are specific instances of a user client 701. In one or more embodiments, the alternate title(s) processor 204, weight processor 206, title standardization processor 208, map to atomic region(s) processor 306, similarity and coverage score processor 312, map between locations processor 322, map between pair of location and title processor 402, and career explorer processor 502 can be implemented as a respective application on an application server 706 or an offline data processing processor 732, such as by incorporating the corresponding processor(s) in the application server 706 or the offline data processing processor 732, respectively. In one or more embodiments, the database 104 and/or 314 are a part of the data layer coupled to offline data processing module 732. In one or more embodiments, the database 104 and/or 314 are part of the data layer.

The computer network environment 700 can include a social networking system 702 that includes one or more application servers 706 that provide any number of applications and services that leverage the social graph data database 728 maintained by the social networking system 702. For example, the social networking system 702 may provide a photo sharing application, a job posting and browsing service, a question-and-answer service to provide a job recommendation or other career information, and so forth, which may include presentation of advertisements or other content, such as an article, a post by another user (e.g., on behalf of themselves or a business), a comment to a post, an indication of a significant milestone being achieved by another user (e.g., a work or wedding anniversary, a birthday, or other milestone), or other content using the service.

The social network environment 700 can provide a social networking service. A social networking service is an online service, platform and/or site that allows users of the service to build or reflect social networks or social relations among members. Typically, users construct profiles, which may include characteristics (e.g., personal information), such as the member's name, contact information, employment information, photographs, personal messages, status information, links to web-related content, blogs, and so on. In order to build or reflect these social networks or social relations among members, the social networking environment 700 allows members to identify, and establish links or connections with other members. For instance, in the context of a business networking service (a type of social networking service), a person may establish a link or connection with his or her business contacts, including work colleagues, clients, customers, personal contacts, and so on. With a social networking service, a person may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of business networking purposes and a social networking service may likewise be used for business networking purposes as well as or in place of social networking purposes.

As shown in FIG. 12, the front end includes the UI 506 and the user client(s) 701A and 701B. The user clients 701A and 701B render web pages presented using the UI 506.

The application logic layer can include various application servers 706, which, in conjunction with the UI 506, generate various UIs (e.g., web pages) with data retrieved from one or more sources of various data sources in the data layer. In some embodiments, individual application(s) on the application server 706 can be used to implement the functionality associated with various applications, services and/or features of the social networking environment 700. For instance, a social networking service may provide a broad variety of applications and services, to include the ability to search for and browse profile pages, job listings, career information, job recommendations, or news articles. Additionally, applications and services may allow users to share content with one another, for example, via email, messages, and/or content postings (sometimes referred to as status updates, such as on a profile page) via a data feed (e.g., specifically tailored) to a user. The application servers 706 can provide the functionality that provides career information to the clients 701A-B associated with users of the social networking system 702.

As shown in FIG. 7, the data layer includes several databases, such as the database 102 for storing profile data, including both user profile data as well as profile data for various entities (e.g., companies, schools, non-profit organizations, government organizations, and other organizations) represented in the social graph maintained by the social networking service, such as in the social graph data database 728. Consistent with some embodiments, when a person initially registers to become a user of the social networking service, the person can be prompted to provide some personal information, such as his or her name, age (e.g., birthdate), gender, interests, contact information, home town, address, the names of the user's spouse and/or family users, educational background (e.g., schools, majors, matriculation and/or graduation dates, etc.), employment history, skills, professional organizations, and so on. This information, generally referred to as user profile information or user characteristic(s), is stored, for example, in the database 102.

Similarly, when a representative of an organization initially registers the organization with the social networking service (e.g., represented by the social networking system 702), the representative may be prompted to provide certain information about the organization. This information—generally referred to as entity profile information—may be stored, for example, in the database 102 or another database (not shown). With some embodiments, the profile data may be processed (e.g., in the background or offline, by the offline data processing module 732) to generate various derived profile data. For example, if a user has provided information about various job titles the user has held with the same or different companies, or for how long, this information can be used to infer or derive a user profile attribute indicating the user's overall seniority level, or seniority level within a particular entity. With some embodiments, importing or otherwise accessing data from one or more externally hosted data sources may enhance profile data for both users and organizations. For instance, with companies in particular, financial data may be imported from one or more external data sources, and made part of an entity's profile. Another example can include importing information regarding an entity that has an auto-created profile page.

The offline data processing processor 732 can be used to perform analytics on the data stored in the persistent storage (e.g., 102, 728, 730, 104, and/or 314). Analytics includes mining data to determine, for example, common characteristics between users that have selected an ad or other content (such as by clicking on the content). Analytics can help a user determine career information, which can be used to help the user decide a career path. Analytics can help a user find a job opening that is consistent with the information in the user profile of the database 102.

Once registered, a user may invite other users, or be invited by other users, to connect via the environment 700. A “connection” may require a bi-lateral agreement by the users, such that both users acknowledge the establishment of the connection. Similarly, with some embodiments, a user may elect to “follow” another user. In contrast to establishing a connection, the concept of “following” another user typically can be a unilateral operation, and at least with some embodiments, does not require acknowledgement or approval by the user that is being followed. When one user follows another user, the user who is following may receive content postings, status updates, or other content postings published by the user being followed, or relating to various activities undertaken by the user being followed. Similarly, when a user follows an organization, the user becomes eligible to receive content postings published on behalf of the organization and/or system or service-generated content postings that relate to the organization. For instance, messages or content postings published on behalf of an organization that a user is following will appear in the user's personalized feed. In any case, the various associations and relationships that the users establish with other users, or with other entities and objects, can be stored and maintained within the social graph data database 828.

As users interact with the various applications, services, or content made available via the environment 700, the users' behavior (e.g., content viewed, links selected, etc.) may be monitored and information concerning the users' behavior may be stored, for example, in the user activity and behavior data database 730.

The information may be used to infer a user's intent and/or interests, and to classify the user as being in various categories. For example, if the user performs frequent searches of job listings, thereby exhibiting behavior indicating that the user is a likely job seeker, this information can be used to classify the user as a job seeker. This classification can then be used as an attribute or characteristic. The attribute or characteristic can be used by others to target the user for receiving advertisements, messages, content postings, a job recommendation, or other career information. Accordingly, an entity that has available job openings can publish a content posting that is specifically directed to certain users (e.g., users) of the social networking service who are likely job seekers, and thus, more likely to be receptive to recruiting efforts.

Certain embodiments are described herein as including logic or a number of components, processors, modules, or mechanisms. Modules described herein can include the alternate title(s) 204, weight processor 206, title standardization processor 208, map to atomic region(s) processor 306, similarity and coverage score processor 312, map between locations processor 322, map between pair of location and title processor 402, and career explorer processor 502. Modules or processors may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules or processors. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

In one embodiment, the modules are written in a computer-programming and/or scripting language. Examples of such languages include, but are not limited to, C, C++, C#, Java, JavaScript, Perl, Python, or any other computer programming and/or scripting language now known or later developed.

Similarly, the methods described herein may be at least partially processor-implemented, with a particular processor or processors being an example of hardware. For example, at least some of the operations of a method may be performed by one or more processors or processor-implemented modules.

Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

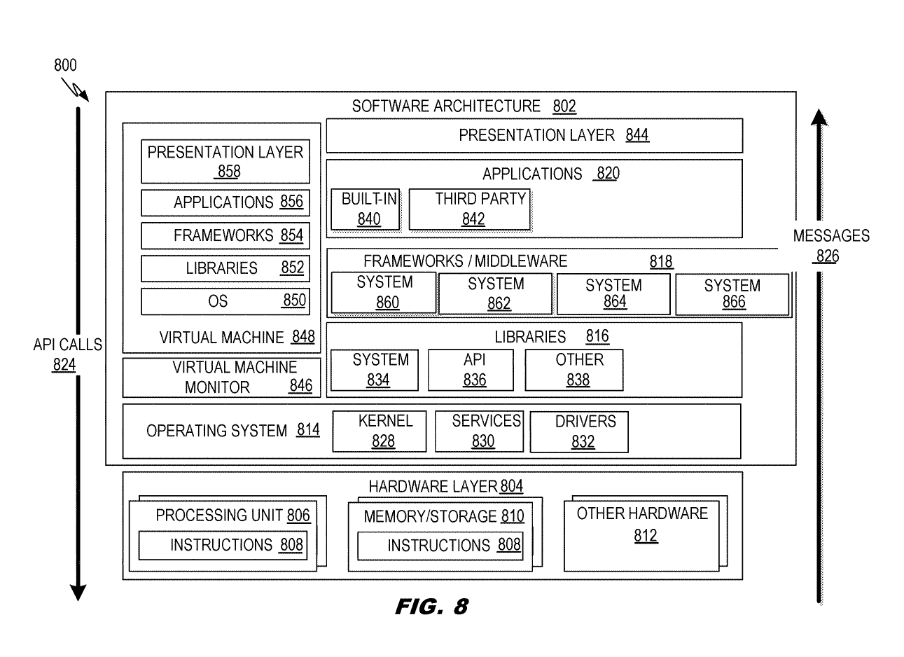

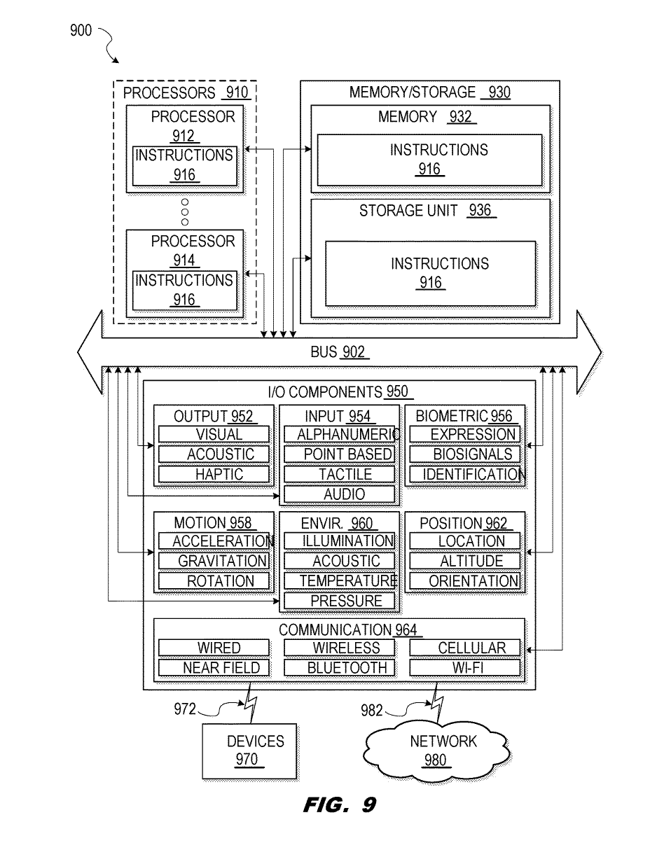

FIG. 8 illustrates, by way of example, a block diagram of an embodiment of a system 800 including a software architecture 802, which may be used in conjunction with various hardware architectures herein described. FIG. 8 is merely a non-limiting example of a software architecture and it will be appreciated that many other architectures may be implemented to facilitate the functionality described herein. The software architecture 802 may be executing on hardware such as machine 900 of FIG. 9 that includes, among other things, processors 910, memory 930, and I/O components 950. A representative hardware layer 804 is illustrated and can represent, for example, the machine 900 of FIG. 9. The representative hardware layer 804 comprises one or more processing units 806 having associated executable instructions 808. Executable instructions 808 represent the executable instructions of the software architecture 802, including implementation of the methods, processors, modules and so forth of FIGS. 1-6. Hardware layer 804 also includes memory and/or storage modules 810, which also have executable instructions 808. Hardware layer 804 may also comprise other hardware as indicated by 812 which represents any other hardware of the hardware layer 804, such as the other hardware illustrated as part of machine 900 or the system 700.

In the example architecture of FIG. 8, the software 802 may be conceptualized as a stack of layers where each layer provides particular functionality. For example, the software 802 may include layers such as an operating system 814, libraries 816, frameworks/middleware 818, applications 820 and presentation layer 822. Operationally, the applications 820 and/or other components within the layers may invoke application programming interface (API) calls 824 through the software stack and receive a response, returned values, and so forth illustrated as messages 826 in response to the API calls 824. The layers illustrated are representative in nature and not all software architectures have all layers. For example, some mobile or special purpose operating systems may not provide a frameworks/middleware layer 818, while others may provide such a layer. Other software architectures may include additional or different layers. Components of the systems 200, 300, 400, and/or 500 can be a part of the frameworks/middleware 818, applications 820, presentation layer 822, or hardware layer 804.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules. The users of the system 700 may call one or more of the APIs in performing operations.

The frameworks 818 (also sometimes referred to as middleware) may provide a higher-level common infrastructure that may be utilized by the applications 820 and/or other software components/modules. For example, the frameworks 818 may provide various graphic user interface (GUI) functions, high-level resource management, high-level location services, and so forth. The frameworks 818 may provide a broad spectrum of other APIs that may be utilized by the applications 820 and/or other software components/modules, some of which may be specific to a particular operating system or platform. The frameworks 818 can include a system 860, system 862, system 864, and/or system 866 framework. The systems 860, 862, 864, and 866 are specific implementations of the systems 200, 300, 400, and 500, respectively. The systems 200, 300, 400, and/or 500 can likewise be implemented as applications 820, applications 856, or frameworks 854.

The applications 820 includes built-in applications 840 and/or third party applications 842. Examples of representative built-in applications 840 may include, but are not limited to, a contacts application, a browser application, a book reader application, a location application, a media application, a messaging application, and/or a game application. Third party applications 842 may include any of the built in applications as well as a broad assortment of other applications. In a specific example, the third party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 842 may invoke the API calls 824 provided by the mobile operating system such as operating system 814 to facilitate functionality described herein.

The applications 820 may utilize built in operating system functions (e.g., kernel 828, services 830 and/or drivers 832), libraries (e.g., system 834, APIs 836, and other libraries 838), frameworks/middleware 818 to create user interfaces to interact with users of the system. Alternatively, or additionally, in some systems interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware machine (such as the machine of FIG. 9, for example). A virtual machine is hosted by a host operating system (operating system 814) and typically, although not always, has a virtual machine monitor 846, which manages the operation of the virtual machine as well as the interface with the host operating system (i.e., operating system 814). A software architecture executes within the virtual machine such as an operating system 850, libraries 852, frameworks/middleware 854, applications 856 and/or presentation layer 858. These layers of software architecture executing within the virtual machine 848 can be the same as corresponding layers previously described or may be different.

FIG. 9 illustrates, by way of example, a block diagram of an embodiment of components of a machine 900 able to read instructions from a machine-readable medium (e.g., a machine-readable storage medium) and perform any one or more of the methodologies or functionality of a module or processor discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions may cause the machine to execute the flow diagrams of FIG. 6 or perform operations of the system 200, 300, 400, and/or 500. Additionally, or alternatively, the instructions may implement the alternate title(s) processor 204, weight processor 206, title standardization processor 208, map to atomic region(s) processor 306, similarity and coverage score processor 312, map between locations processor 322, map between pair of location and title processor 402, and career explorer processor 502 of FIGS. 1-5, and so forth. The instructions transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980, such as a wireless radio transceiver. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### EXAMPLES AND NOTES

The present subject matter can be described by way of several examples.

Example 1 can include or use subject matter (such as an apparatus, a method, a means for performing acts, or a non-transitory machine readable medium including instructions that, when performed by the machine, can cause the machine to perform operations), such as can include or use receiving a request for the career information, the request including one or more job titles and one or more job locations associated with the job titles, the one or more job titles determined in accord with a first title taxonomy used by entries in a first database and the one or more job locations determined in accord with a first location taxonomy used by entries in the first database, mapping the one or more job titles to one or more profession titles, the one or more profession titles determined in accord with a second, different title taxonomy used by entries in a second database, mapping the one or more job locations to one or more profession locations, the one or more profession locations determined in accord with a second, different location taxonomy used by entries in the second database, executing a query for statistics associated with the career information, the query including the one or more profession titles and the one or more profession locations to which the one or more job titles and the one or more job locations respectively map, and providing the career information based on the statistics returned from executing the query.

Example 2 can include or use, or can optionally be combined with the subject matter of Example 1, to include or use, wherein the instructions for mapping the one or more job titles to the one or more profession titles include instructions which, when executed by the machine, cause the machine to perform operations comprising determining alternate titles for each of the one or more profession titles, identifying which of the determined alternate titles and one or more profession titles have an equal job title in the first title taxonomy, and associating each of the one or more profession titles that has an associated alternates title or profession title identified to include the equal job title in the first title taxonomy.

Example 3 can include or use, or can optionally be combined with the subject matter of at least one of Example 2 to include or use, wherein the instructions for mapping the one or more job titles to the one or more profession titles include instructions which, when executed by the machine, cause the machine to perform operations comprising determining a weight for each of the alternates titles and profession title identified to include an equal job title in the first title taxonomy, the weight indicating a confidence that the alternate titles or profession title is supposed to map to the equal job title, wherein a sum of all alternate titles and profession titles mapped to a job title in the first title taxonomy is about one.

Example 4 can include or use, or can optionally be combined with the subject matter of at least one of Example 3 to include or use, wherein the instructions for determining the weight for each of the alternate titles and profession titles identified to include an equal job title in the first title taxonomy include instructions which, when executed by the machine, cause the machine to perform operations comprising estimating a proportion of the population of the one or more profession locations or one or more job locations that includes the alternate titles or profession titles, normalizing the estimated proportion such that the summed estimated proportions for a respective job title of the one or more job titles equals about one, and using the normalized estimated proportion as the weight.

Example 5 can include or use, or can optionally be combined with the subject matter of at least one of at least one of Examples 1-4 to include or use, wherein the instructions for mapping the one or more job locations to the one or more profession locations include instructions which, when executed by the machine, cause the machine to perform operations comprising mapping each job location of the one or more job locations to one or more atomic regions, the one or more atomic regions determined in accord with the third, different location taxonomy, mapping each profession location of the one or more profession locations to the one or more atomic regions, identifying overlap between atomic regions to which a respective job location is mapped and atomic regions to which a respective profession location is mapped, and associating the respective job location with the respective profession location if the identified overlap is not a null set.

Example 6 can include or use, or can optionally be combined with the subject matter of at least one of Example 5 to include or use, wherein the instructions for mapping the one or more job locations to the one or more profession locations include instructions which, when executed by the machine, cause the machine to perform operations comprising determining a coverage score for the associated respective job location and respective profession location, the coverage score indicating an amount of geographic overlap between the respective job location and the respective profession location, and associating the coverage score with the associated respective job location and respective profession location.

Example 7 can include or use, or can optionally be combined with the subject matter of at least one of Example 6 to include or use, wherein the instructions for mapping the one or more job locations to the one or more profession locations include instructions which, when executed by the machine, cause the machine to perform operations comprising determining a similarity score for the associated respective job location and respective profession location, the similarity score indicating an amount of demographic overlap between the respective job location and the respective profession location, and associating the similarity score with the associated respective job location and respective profession location.

Example 8 can include or use, or can optionally be combined with the subject matter of at least one of Example 7 to include or use, wherein the instructions for determining a similarity score for the associated respective job location and respective profession location include instructions which, when executed by the machine, cause the machine to perform operations comprising determining a Jaccard coefficient between the mapped job locations and profession locations.

Example 9 can include or use, or can optionally be combined with the subject matter of at least one of Example 7 to include or use, wherein the instructions for determining a similarity score for the associated respective job location and respective profession location include instructions which, when executed by the machine, cause the machine to perform operations comprising determining a first population of a first region defined by an intersection between the mapped job location and profession location, determining a second population of a second region defined by a union between the mapped job location and profession location, and dividing the determined first population by the determined second population to produce the similarity score.

Example 10 can include or use, or can optionally be combined with the subject matter of at least one of at least one of Examples 1-9 to include or use, wherein the career information includes a job recommendation, wherein the statistics include two or more of an unemployment rate in the one or more profession locations to which the one or more job locations map, a cost of living in the one or more profession locations to which the one or more job locations map, and salary information for occupations with profession titles to which the one or more job titles map.

Example 11 can include or use, or can optionally be combined with the subject matter of at least one of at least one of Examples 1-9 to include or use, wherein the statistics include salary information for occupations with profession titles to which the one or more job titles map and career information includes a job salary and the non-transitory machine-readable medium includes further instructions which, when executed by the machine, cause the machine to perform operations comprising determining a weighted average of the salary information, each weight of the weighted average indicating a proportion of a population in a profession location to which the one or more job locations map that includes the corresponding profession title, and providing the determined weighted average as the career information.

Example 12 can include or use subject matter (such as an apparatus, a method, a means for performing acts, or a non-transitory machine readable medium including instructions that, when performed by the machine, can cause the machine to perform operations), such as can include or use a method comprising operations for providing a user with career information, the operations comprising receiving, at a career explorer processor, a request for career information, the request including one or more job titles and one or more job locations associated with the job titles, the one or more job titles determined in accord with a first title taxonomy used by entries in a first database and the one or more job locations determined in accord with a first location taxonomy used by entries in the first database, mapping, using a title mapping system communicatively coupled to the career explorer processor, the one or more job titles to one or more profession titles, the one or more profession titles determined in accord with a second, different title taxonomy used by entries in a second database, mapping, using a location mapping system communicatively coupled to the career explorer processor, the one or more job locations to one or more profession locations, the one or more profession locations determined in accord with a second, different location taxonomy used by entries in the second database, executing, using the career explorer processor, a query for statistics associated with the career information, the query including the one or more profession titles and the one or more profession locations to which the one or more job titles and the one or more job locations respectively map, and providing, using a user interface communicatively coupled to the career explorer processor, the career information based on the statistics returned from executing the query.

Example 13 can include or use, or can optionally be combined with the subject matter of at least one of Example 12 to include or use, wherein mapping the one or more job titles to the one or more profession titles includes operations comprising determining, using the title mapping system, alternate titles for each of the one or more profession titles, identifying, using the title mapping system, which of the determined alternate titles and one or more profession titles have an equal job title in the first title taxonomy, and associating, using the title mapping system, each of the one or more profession titles that has an associated alternates title or profession title identified to include the equal job title in the first title taxonomy.

Example 14 can include or use, or can optionally be combined with the subject matter of at least one of Example 13 to include or use, wherein mapping the one or more job titles to the one or more profession titles includes operations comprising determining, using the title mapping system, a weight for each of the alternates titles and profession title identified to include an equal job title in the first title taxonomy, the weight indicating a confidence that the alternate titles or profession title is supposed to map to the equal job title, wherein a sum of all alternate titles and profession titles mapped to a job title in the first title taxonomy is about one.

Example 15 can include or use, or can optionally be combined with the subject matter of at least one of Example 14 to include or use, wherein determining the weight for each of the alternate titles and profession titles identified to include an equal job title in the first title taxonomy includes operations comprising estimating a proportion of the population of the one or more profession locations or one or more job locations that includes the alternate titles or profession titles, normalizing the estimated proportion such that the summed estimated proportions for a respective job title of the one or more job titles equals about one, and using the normalized estimated proportion as the weight.

Example 16 can include or use subject matter (such as an apparatus, a method, a means for performing acts, or a non-transitory machine readable medium including instructions that, when performed by the machine, can cause the machine to perform operations), such as can include or use a career explorer processor to process a request for career information, the request including one or more job titles and one or more job locations associated with the job titles, the one or more job titles determined in accord with a first title taxonomy used by entries in a first database and the one or more job locations determined in accord with a first location taxonomy used by entries in the first database, a title mapping system communicatively coupled to the career explorer processor, the title mapping system to map one or more job titles to one or more profession titles, the one or more profession titles determined in accord with a second, different title taxonomy used by entries in a second database, a location mapping system communicatively coupled to the career explorer processor, the location mapping system to map one or more job locations to one or more profession locations, the one or more profession locations determined in accord with a second, different location taxonomy used by entries in the second database, the career explorer processor, further to execute a query for statistics associated with the career information, the query including the one or more profession titles and the one or more profession locations to which the one or more job titles and the one or more job locations respectively map, and a user interface communicatively coupled to the career explorer processor to provide the career information based on the statistics returned from executing the query.

Example 17 can include or use, or can optionally be combined with the subject matter of at least one of Example 16 to include or use, wherein mapping, by the location mapping system, the one or more job locations to the one or more profession locations includes the location mapping system further to map each job location of the one or more job locations to one or more atomic regions, the one or more atomic regions determined in accord with the third, different location taxonomy, map each profession location of the one or more profession locations to the one or more atomic regions, identify overlap between atomic regions to which a respective job location is mapped and atomic regions to which a respective profession location is mapped, and associate the respective job location with the respective profession location if the identified overlap is not a null set.

Example 18 can include or use, or can optionally be combined with the subject matter of at least one of Example 17 to include or use wherein mapping, by the location mapping system, the one or more job locations to the one or more profession locations further includes the location mapping system to determine a coverage score for the associated respective job location and respective profession location, the coverage score indicating an amount of geographic overlap between the respective job location and the respective profession location, and associate the coverage score with the associated respective job location and respective profession location.

Example 19 can include or use, or can optionally be combined with the subject matter of at least one of Example 18 to include or use, wherein mapping, using the location mapping system. the one or more job locations to the one or more profession locations includes the location mapping system further to determine a similarity score for the associated respective job location and respective profession location, the similarity score indicating an amount of demographic overlap between the respective job location and the respective profession location, and associate the similarity score with the associated respective job location and respective profession location.

Example 20 can include or use, or can optionally be combined with the subject matter of at least one of Example 19 to include or use, wherein determining, using the location mapping system, a similarity score for the associated respective job location and respective profession location include the location mapping system further to (1) determine a Jaccard coefficient between the mapped job locations and profession locations, or (2) determine a first population of a first region defined by an intersection between the mapped job location and profession location, determine a second population of a second region defined by a union between the mapped job location and profession location, and divide the determined first population by the determined second population to produce the similarity score.

The above Description of Embodiments includes references to the accompanying figures, which form a part of the detailed description. The figures show, by way of illustration, specific embodiments in which methods, apparatuses, and systems discussed herein can be practiced. These embodiments are also referred to herein as “examples” or “embodiments”. Such embodiments (e.g., examples) can include elements in addition to those shown or described. However, the present inventors also contemplate embodiments in which only those elements shown or described are provided. Moreover, the present inventors also contemplate embodiments using any combination or permutation of those elements shown or described (or one or more aspects thereof), either with respect to a particular embodiment (or one or more aspects thereof), or with respect to other embodiments (or one or more aspects thereof) shown or described herein.

The flowchart and block diagrams in the FIGS. illustrate the architecture, functionality, and operation of possible implementations of systems, methods and computer program products according to various aspects of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The functions or techniques described herein can be implemented in software or a combination of software and human implemented procedures. The software can consist of computer executable instructions stored on computer readable media such as memory or other type of storage devices. The term “computer readable media” is also used to represent any means by which the computer readable instructions can be received by the computer, such as by different forms of wired or wireless transmissions. Further, such functions correspond to modules, which are software, hardware, firmware or any combination thereof. Multiple functions can be performed in one or more modules as desired, and the embodiments described are merely examples. The software can be executed on a digital signal processor, ASIC, microprocessor, or other type of processor operating on a computer system, such as a personal computer, server or other computer system.

The above description is intended to be illustrative, and not restrictive. For example, the above-described embodiments (or one or more aspects thereof) can be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Description of Embodiments, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A non-transitory machine-readable medium comprising instructions stored thereon which, when executed by a machine, cause the machine to perform operations for providing career information, the operations comprising:
receiving a request for the career information, the request including one or more job titles and one or more job locations associated with the job titles, the one or more job titles determined in accord with a first title taxonomy used by entries in a first database and the one or more job locations determined in accord with a first location taxonomy used by entries in the first database;
mapping the one or more job titles to one or more profession titles, the one or more profession titles determined in accord with a second, different title taxonomy used by entries in a second database;
mapping the one or more job locations to one or more profession locations, the one or more profession locations determined in accord with a second, different location taxonomy used by entries in the second database;
executing a query for statistics associated with the career information, the query including the one or more profession titles and the one or more profession locations to which the one or more job titles and the one or more job locations respectively map; and
providing the career information based on the statistics returned from executing the query.

2. The non-transitory machine-readable medium of claim 1, wherein the instructions for mapping the one or more job titles to the one or more profession titles include instructions which, when executed by the machine, cause the machine to perform operations comprising:
determining alternate titles for each of the one or more profession titles;
identifying which of the determined alternate titles and one or more profession titles have an equal job title in the first title taxonomy; and
associating each of the one or more profession titles that has an associated alternates title or profession title identified to include the equal job title in the first title taxonomy.

3. The non-transitory machine-readable medium of claim 2, wherein the instructions for mapping the one or more job titles to the one or more profession titles include instructions which, when executed by the machine, cause the machine to perform operations comprising:
determining a weight for each of the alternates titles and profession title identified to include an equal job title in the first title taxonomy, the weight indicating a confidence that the alternate titles or profession title is supposed to map to the equal job title, wherein a sum of all alternate titles and profession titles mapped to a job title in the first title taxonomy is about one.

4. The non-transitory machine-readable medium of claim 3, wherein the instructions for determining the weight for each of the alternate titles and profession titles identified to include an equal job title in the first title taxonomy include instructions which, when executed by the machine, cause the machine to perform operations comprising:
estimating a proportion of the population of the one or more profession locations or one or more job locations that includes the alternate titles or profession titles;
normalizing the estimated proportion such that the summed estimated proportions for a respective job title of the one or more job titles equals about one; and
using the normalized estimated proportion as the weight.

5. The non-transitory machine-readable medium of claim 1 wherein the instructions for mapping the one or more job locations to the one or more profession locations include instructions which, when executed by the machine, cause the machine to perform operations comprising:
mapping each job location of the one or more job locations to one or more atomic regions, the one or more atomic regions determined in accord with the third, different location taxonomy;
mapping each profession location of the one or more profession locations to the one or more atomic regions;
identifying overlap between atomic regions to which a respective job location is mapped and atomic regions to which a respective profession location is mapped; and
associating the respective job location with the respective profession location if the identified overlap is not a null set.

6. The non-transitory machine-readable medium of claim 5, wherein the instructions for mapping the one or more job locations to the one or more profession locations include instructions which, when executed by the machine, cause the machine to perform operations comprising:
determining a coverage score for the associated respective job location and respective profession location, the coverage score indicating an amount of geographic overlap between the respective job location and the respective profession location; and
associating the coverage score with the associated respective job location and respective profession location.

7. The non-transitory machine-readable medium of claim 6, wherein the instructions for mapping the one or more job locations to the one or more profession locations include instructions which, when executed by the machine, cause the machine to perform operations comprising:
determining a similarity score for the associated respective job location and respective profession location, the similarity score indicating an amount of demographic overlap between the respective job location and the respective profession location; and
associating the similarity score with the associated respective job location and respective profession location.

8. The non-transitory machine-readable medium of claim 7, wherein the instructions for determining a similarity score for the associated respective job location and respective profession location include instructions which, when executed by the machine, cause the machine to perform operations comprising:
determining a Jaccard coefficient between the mapped job locations and profession locations.

9. The non-transitory machine-readable medium of claim 7, wherein the instructions for determining a similarity score for the associated respective job location and respective profession location include instructions which, when executed by the machine, cause the machine to perform operations comprising:
determining a first population of a first region defined by an intersection between the mapped job location and profession location;
determining a second population of a second region defined by a union between the mapped job location and profession location; and
dividing the determined first population by the determined second population to produce the similarity score.

10. The non-transitory machine-readable medium of claim 1, wherein the career information includes a job recommendation, wherein the statistics include two or more of an unemployment rate in the one or more profession locations to which the one or more job locations map, a cost of living in the one or more profession locations to which the one or more job locations map, and salary information for occupations with profession titles to which the one or more job titles map.

11. The non-transitory machine-readable medium of claim 1, wherein the statistics include salary information for occupations with profession titles to which the one or more job titles map and career information includes a job salary and the non-transitory machine-readable medium includes further instructions which, when executed by the machine, cause the machine to perform operations comprising:
determining a weighted average of the salary information, each weight of the weighted average indicating a proportion of a population in a profession location to which the one or more job locations map that includes the corresponding profession title; and
providing the determined weighted average as the career information.

12. A method comprising operations for providing a user with career information, the operations comprising:
receiving, at a career explorer processor, a request for career information, the request including one or more job titles and one or more job locations associated with the job titles, the one or more job titles determined in accord with a first title taxonomy used by entries in a first database and the one or more job locations determined in accord with a first location taxonomy used by entries in the first database;
mapping, using a title mapping system communicatively coupled to the career explorer processor, the one or more job titles to one or more profession titles, the one or more profession titles determined in accord with a second, different title taxonomy used by entries in a second database;
mapping, using a location mapping system communicatively coupled to the career explorer processor, the one or more job locations to one or more profession locations, the one or more profession locations determined in accord with a second, different location taxonomy used by entries in the second database;
executing, using the career explorer processor, a query for statistics associated with the career information, the query including the one or more profession titles and the one or more profession locations to which the one or more job titles and the one or more job locations respectively map; and
providing, using a user interface communicatively coupled to the career explorer processor, the career information based on the statistics returned from executing the query.

13. The method of claim 12, wherein mapping the one or more job titles to the one or more profession titles includes operations comprising:
determining, using the title mapping system, alternate titles for each of the one or more profession titles;
identifying, using the title mapping system, which of the determined alternate titles and one or more profession titles have an equal job title in the first title taxonomy; and
associating, using the title mapping system, each of the one or more profession titles that has an associated alternates title or profession title identified to include the equal job title in the first title taxonomy.

14. The method of claim 13, wherein mapping the one or more job titles to the one or more profession titles includes operations comprising:
determining, using the title mapping system, a weight for each of the alternates titles and profession title identified to include an equal job title in the first title taxonomy, the weight indicating a confidence that the alternate titles or profession title is supposed to map to the equal job title, wherein a sum of all alternate titles and profession titles mapped to a job title in the first title taxonomy is about one.

15. The method of claim 14, wherein determining the weight for each of the alternate titles and profession titles identified to include an equal job title in the first title taxonomy includes operations comprising:
estimating a proportion of the population of the one or more profession locations or one or more job locations that includes the alternate titles or profession titles;
normalizing the estimated proportion such that the summed estimated proportions for a respective job title of the one or more job titles equals about one; and
using the normalized estimated proportion as the weight.

16. A system comprising:
a career explorer processor to process a request for career information, the request including one or more job titles and one or more job locations associated with the job titles, the one or more job titles determined in accord with a first title taxonomy used by entries in a first database and the one or more job locations determined in accord with a first location taxonomy used by entries in the first database;
a title mapping system communicatively coupled to the career explorer processor, the title mapping system to map one or more job titles to one or more profession titles, the one or more profession titles determined in accord with a second, different title taxonomy used by entries in a second database;
a location mapping system communicatively coupled to the career explorer processor, the location mapping system to map one or more job locations to one or more profession locations, the one or more profession locations determined in accord with a second, different location taxonomy used by entries in the second database;
the career explorer processor, further to execute a query for statistics associated with the career information, the query including the one or more profession titles and the one or more profession locations to which the one or more job titles and the one or more job locations respectively map; and
a user interface communicatively coupled to the career explorer processor to provide the career information based on the statistics returned from executing the query.

17. The system of claim 16, wherein mapping, by the location mapping system, the one or more job locations to the one or more profession locations includes the location mapping system further to:
map each job location of the one or more job locations to one or more atomic regions, the one or more atomic regions determined in accord with the third, different location taxonomy;
map each profession location of the one or more profession locations to the one or more atomic regions;
identify overlap between atomic regions to which a respective job location is mapped and atomic regions to which a respective profession location is mapped; and
associate the respective job location with the respective profession location if the identified overlap is not a null set.

18. The system of claim 17, wherein mapping, by the location mapping system, the one or more job locations to the one or more profession locations further includes the location mapping system to:
determine a coverage score for the associated respective job location and respective profession location, the coverage score indicating an amount of geographic overlap between the respective job location and the respective profession location; and
associate the coverage score with the associated respective job location and respective profession location.

19. The system of claim 18, wherein mapping, using the location mapping system, the one or more job locations to the one or more profession locations includes the location mapping system further to:
determine a similarity score for the associated respective job location and respective profession location, the similarity score indicating an amount of demographic overlap between the respective job location and the respective profession location; and
associate the similarity score with the associated respective job location and respective profession location.

20. The system of claim 18, wherein determining, using the location mapping system, a similarity score for the associated respective job location and respective profession location include the location mapping system further to:
(1) determine a Jaccard coefficient between the mapped job locations and profession locations; or
(2) determine a first population of a first region defined by an intersection between the mapped job location and profession location;
determine a second population of a second region defined by a union between the mapped job location and profession location; and
divide the determined first population by the determined second population to produce the similarity score.
